(19) United States
(12) Patent Application Publication
(10) Pub. No.: US 2023/0189404 A1
(43) Pub. Date: Jun. 15, 2023

(54) Surface Heating Heater Pipe and Aerosol Generating Device Including the Same

(71) Applicant: INNO-IT CO., LTD., Busan (KR)

(72) Inventors: Han Seok Chae, Gyeonggi-do (KR); Il Kwon Song, Gyeonggi-do (KR); Young Sun Oh, Gyeonggi-do (KR); Beom Chang Oh, Busan (KR)

(21) Appl. No.: 18/079,472

(22) Filed: Dec. 12, 2022

(30) Foreign Application Priority Data
Dec. 14, 2021 (KR) 10-2021-0179082
Nov. 11, 2022 (KR) 10-2022-0150395

(51) Int. Cl. H05B 3/48; H05B 3/14; G05D 23/24; A24F 40/46; A24F 40/20; A24F 40/51; A24F 40/57

(52) U.S. Cl. CPC H05B 3/48; H05B 3/145; G05D 23/2401; A24F 40/46; A24F 40/20; A24F 40/51; A24F 40/57; H05B 2214/04; H05B 2203/016; H05B 2203/013

(57) ABSTRACT

The present disclosure relates to a surface heating heater pipe and an aerosol generating device including the same, and more particularly, to a surface heating heater pipe having improved performance by implementing a surface heating structure using graphene and an aerosol generating device including the same. A heater pipe for an aerosol generating device for transferring heat to an aerosol-forming article includes a body formed of metal and having a shape of a pipe having a space for accommodating the aerosol-forming article, a first insulating layer formed on an outer surface of the body, a graphene layer formed on the first insulating layer by deposition, and a second insulating layer formed on the graphene layer.

### TECHNICAL FIELD

The present disclosure relates to a surface heating heater pipe and an aerosol generating device including the same, and more particularly, to a surface heating heater pipe having improved performance by implementing a surface heating structure using graphene and an aerosol generating device including the same.

### BACKGROUND

Aerosols are small liquid or solid particles suspended in the air and usually have a size of 0.001 to 1.0 μm. In particular, in some cases, people inhale aerosols derived from various types of cigarette-type aerosol generating articles. For example, according to demand of consumers who prefer cigarette-type conventional cigarettes, electronic cigarettes having a filter portion and a cigarette portion shape of a conventional cigarette have also been proposed, and the electronic cigarettes are configured such that, when an inhalation substance contained in the cigarette portion is vaporized by an electronic heater, users inhale the substance through a filter unit having a configuration equivalent to that of a conventional cigarette. FIG. 1 is a view illustrating an example of an aerosol generating device according to the related art. Referring to FIG. 1, the aerosol generating device 100 includes a cavity 20 into which a cigarette-type aerosol generating article 10 is inserted, and a heater 30 in the form of a pipe is provided on an outer periphery of the cavity 20, for example, to heat the cigarette-type aerosol generating article 10 inserted into the aerosol generating device 100 to generate an aerosol. In addition, the aerosol generating device 100 includes a battery 40 for supplying power to the heater 30 and a controller 50 configured to control power supplied from the battery 40 to the heater 30. In the related art described above, power is supplied from the battery 40 to the heater 30 under the control of the controller 50 and the cigarette-type aerosol generating article 10 is heated by heat generated by the heater 30, so that an aerosol is generated from an aerosol-generating substrate within the cigarette-type aerosol generating article 10.

The heater 30 is a key element directly related to a user experience in the aerosol generating device, and in particular, it is necessary to improve the capability of the heater 30 to transfer heat to the aerosol generating article 10 inserted therein. Therefore, in order to improve a structure of the heater 30, various improvements, such as ceramic heaters or film-type heaters, have been attempted. In addition, since the aerosol generating device is important in portability, there should be no difficulty in long-term use, while the size of the battery is reduced. Therefore, a high-efficiency low-power design is particularly required. Korean Patent Registration No. 10-2017004 discloses a film heater having a nano-carbon particle-based surface heating, but a further improved effect in heating uniformity is required.

### SUMMARY

An aspect of the present disclosure is to provide a heater pipe capable of generating an aerosol by heating an aerosol-forming article uniformly and at a rapid rate of temperature increase using a graphene surface exothermic layer, and an aerosol generating device including the same.

An embodiment of the present disclosure provides a heater pipe for an aerosol generating device for transferring heat to an aerosol-forming article, including: a body formed of metal and having a shape of a hollow pipe for accommodating the aerosol-forming article; a first insulating layer formed on an outer surface of the body; an exothermic layer formed on the first insulating layer by deposition; and a second insulating layer formed on the exothermic layer.

In another aspect of the embodiment, the exothermic layer may be a graphene layer.

In another aspect of the embodiment, the heater pipe may further include: a connector portion formed by removing a portion of the second insulating layer, and exposed to the outside, wherein the graphene layer is connected to an external power source through the connector portion.

In another aspect of the embodiment, the graphene layer may be formed by depositing graphene in a pattern.

In another aspect of the embodiment, at least one of the first insulating layer and the second insulating layer may be a polyimide film.

In another aspect of the embodiment, the first insulating layer, the graphene layer, and the second insulating layer may partially extend from the outer surface of the body to form a lower surface of a pipe heater.

In another aspect of the embodiment, the first insulating layer and the second insulating layer may have an extension portion partially extending to the outside of the body, and a connector portion connecting the graphene layer to an external power source may be formed on the extension portion.

In another aspect of the embodiment, the heater pipe may further include: a sensor layer attached to an outer surface of the second insulating layer and having a sensor pattern for sensing a temperature printed on the insulating film.

In another aspect of the embodiment, the first insulating layer, the second insulating layer, and the sensor layer may have an extension portion partially extending to the outside of the body, and a connector portion connecting the graphene layer to an external power source and a terminal portion extending from the sensor pattern are provided on the extension portion.

In another aspect of the embodiment, the first insulating layer and the second insulating layer may partially extend from the outer surface of the body to form a lower surface of a pipe heater, and an etched exothermic pattern may be formed between the first insulating layer and the second insulating layer of the lower surface.

In another aspect of the embodiment, the graphene layer may be connected to an external power source through a boost converter to increase a supplied voltage.

Another aspect of the embodiment provides a laminated heater pipe formed by vertically laminating a plurality of heater pipes according to claim 1, wherein a cross-sectional area of a hollow of a heater pipe laminated at the bottom is smaller than or equal to a cross-sectional area of a hollow of a heater pipe laminated at the top.

In another aspect of the embodiment, a cross-section of an outer surface of the laminated heater pipe may be circular, and a cross-section of the hollow thereof may also be circular.

In another aspect of the embodiment, a cross-section of an outer surface of the laminated heater pipe may be quadrangular, and a cross-section of the hollow thereof may be circular.

In another aspect of the embodiment, a cross-section of an outer surface of the laminated heater pipe may be quadrangular, and a cross-section of the hollow thereof may also be quadrangular.

In another aspect of the embodiment, the laminated heater pipe may further include: an electrode layer printed on the first insulating layer, wherein an exothermic layer is formed on the electrode layer, and is a thin film formed by applying a paste composition including at least one of platinum-based ruthenium, palladium, and silver and then sintering.

In another aspect of the embodiment, the exothermic layer may have an electrical resistance of 0.6Ω to 1.4Ω.

In another aspect of the embodiment, the electrode layer may include one or more negative (−) electrodes and two or more positive (+) electrodes.

In another aspect of the embodiment, the exothermic layer and the second insulating layer may each have an electrode exposure hole exposing the electrode of the electrode layer, and a wire for applying power may be connected to the electrode.

In another aspect of the embodiment, a temperature change resistance (TCR) of the exothermic layer connected to the electrode layer may be measured and used to control a temperature of a heater.

In another aspect of the embodiment, the first insulating layer, the exothermic layer, and the second insulating layer may have a hole located at overlapping positions to expose the heater pipe, wherein the laminated heater pipe further includes a thermocouple for temperature measurement directly welded to the heater pipe exposed through the hole.

In another aspect of the embodiment, an aerosol generating device may include any one of the heater pipes described above.

In the heater pipe and the aerosol generating device including the same provided by the present disclosure, an insulating layer is formed on a metal pipe and graphene is deposited to form a surface heating layer, thereby obtaining thermal and electrical conductivity and a very fast heating rate.

In addition, in the heater pipe and the aerosol generating device including the same provided by the present disclosure, a surface heating layer evenly heats a metal pipe and the heated metal pipe heats an aerosol-forming material inserted therein, so that the entire range of the aerosol-forming material may be heated evenly at the same time.

In addition, in the heater pipe and the aerosol generating device including the same provided by the present disclosure, the surface heating layer is also present on a lower surface of the heater pipe, so that the inserted aerosol-forming material may be heated more evenly, and since the surface heating layer and a connector are integrally formed, manufacturing is facilitated.

In addition, the heater pipe and the aerosol generating device including the same provided by the present disclosure may be equipped with a film-type temperature sensor to facilitate temperature control, while maintaining compactness.

### BRIEF DESCRIPTION OF THE DRAWINGS

FIG. 1 is an internal configuration view illustrating an example of an aerosol generating device according to the related art;

FIG. 2 is a perspective view of a heater pipe according to a first embodiment of the present disclosure;

FIG. 3 is a partial cross-sectional view of a heater pipe according to the first embodiment of the present disclosure;

FIG. 4 is an unfolded exploded view illustrating a first insulating layer and a graphene layer of a heater pipe according to a second embodiment of the present disclosure;

FIG. 5 is an unfolded exploded view illustrating a first insulating layer and a graphene layer of a heater pipe according to a third embodiment of the present disclosure;

FIG. 6 is an unfolded exploded view illustrating a first insulating layer and a graphene layer of a heater pipe according to a fourth embodiment of the present disclosure;

FIG. 7 is a partial cross-sectional view of a heater pipe according to a fifth embodiment of the present disclosure;

FIG. 8 is an unfolded exploded view illustrating an insulating film and a sensor pattern of a heater pipe according to a fifth embodiment of the present disclosure;

FIG. 9 is a block diagram illustrating a configuration of a heater pipe according to a sixth embodiment of the present disclosure;

FIG. 10 is an exploded view of a laminated heater pipe that may be formed by laminating heater pipes according to an embodiment of the present disclosure;

FIG. 11 is a top view of each of laminated heater pipes in a laminated heater pipe according to an embodiment of the present disclosure;

FIG. 12 is a top view of each of laminated heater pipes in a laminated heater pipe according to another embodiment of the present disclosure;

FIG. 13 is a top view of each of laminated heater pipes in a laminated heater pipe according to another embodiment of the present disclosure;

FIG. 14 is a partial cross-sectional view of a laminated heater pipe according to a seventh embodiment of the present disclosure;

FIG. 15 is a perspective view of a laminated heater pipe according to the seventh embodiment of the present disclosure;

FIG. 16 is an exploded view illustrating each layer of a laminated heater pipe according to the seventh embodiment of the present disclosure;

FIG. 17 is an exploded view illustrating each layer of a laminated heater pipe according to an eighth embodiment of the present disclosure;

FIGS. 18 and 19 are perspective views illustrating each layer of a laminated heater pipe according to the eighth embodiment of the present disclosure;

FIG. 20 is an exploded view illustrating each layer of a laminated heater pipe according to a ninth embodiment;

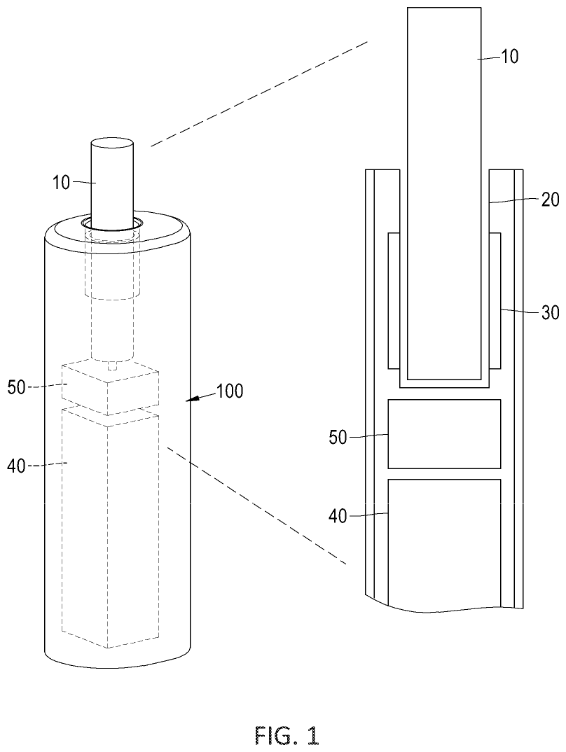

### DETAILED DESCRIPTION

Hereinafter, the present disclosure will be described in more detail with reference to the drawings.

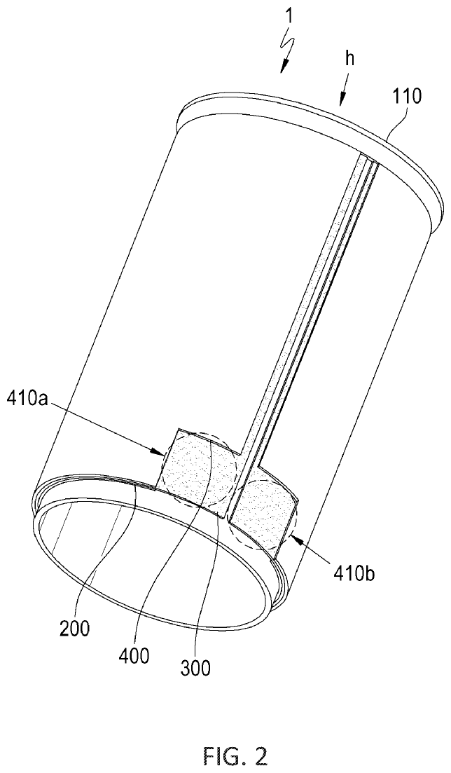

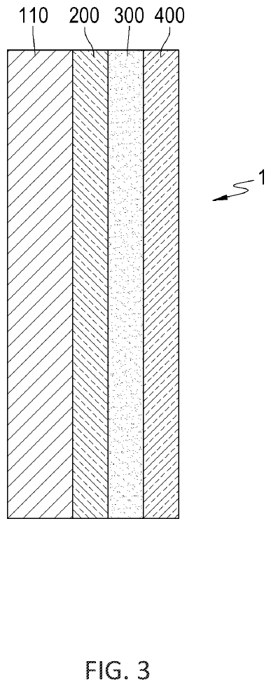

FIG. 2 is a perspective view of a heater pipe according to a first embodiment of the present disclosure, and FIG. 3 is a partial cross-sectional view of a heater pipe according to the first embodiment of the present disclosure. In the present embodiment, a heater pipe 1 includes a body 110 having a pipe shape and formed of a metal material, a first insulating layer 200 formed on an outer surface of the body 110, a graphene layer 300 on the first insulating layer 200, and a second insulating layer 400 on the graphene layer 300.

The body 110 has a pipe shape and have a hollow h formed therein to accommodate an aerosol-forming article so that an aerosol-forming article, such as a cigarette, may be inserted therein. Since the body 110 needs to transfer heat easily to the inserted aerosol-forming article, the body 110 may be formed of a metal having high thermal conductivity. For example, the body 110 may be formed of a stainless steel (SUS) material. The first insulating layer 200 is formed on a side surface of the pipe of the body 110, i.e., on the outer surface of the body 110. The first insulating layer 200 may be formed on the outer surface of the body 110 by a coating process, such as deposition or spraying. Alternatively, the first insulating layer 200 may be formed as an insulating film adhered to the outer surface of the body 110.

The graphene layer 300 is formed on the first insulating layer 200 as a unit for generating heat. For example, the graphene layer 300 may be formed by first forming the first insulating layer 200 on the body 110 and then depositing graphene thereon. In addition, a connector portion for electrical connection may be formed on one side of the graphene layer 300. The second insulating layer 400 is formed on the graphene layer 300. The second insulating layer 400 may also be formed by coating, such as deposition or spraying, or by attaching an insulating film. The connector portions 410a and 410b may be separately formed by deleting a portion of the second insulating layer 400 and attaching a metal pad or forming a soldering pad to a portion of the graphene layer 300 exposed therefrom. The graphene layer 300 may generate heat by connecting the separated connector portions 410a and 410b to an external power source (not shown). In the present embodiment, it is illustrated that the body 110 does not have a lower surface, but in another embodiment, when the body 110 has a lower surface, the first insulating layer 200, the graphene layer 300, and the second insulating layer 400 may also be formed on the lower surface. In this case, the connector portions 410a and 410b may be formed on the lower surface of the body 110. When an exothermic layer (the first insulating layer 200, the graphene layer 300, and the second insulating layer 400) exists on the lower surface of the body 110, heat may be transferred to a lower end portion of the inserted aerosol-forming article, and thus, the aerosol-forming article may be more evenly heated.

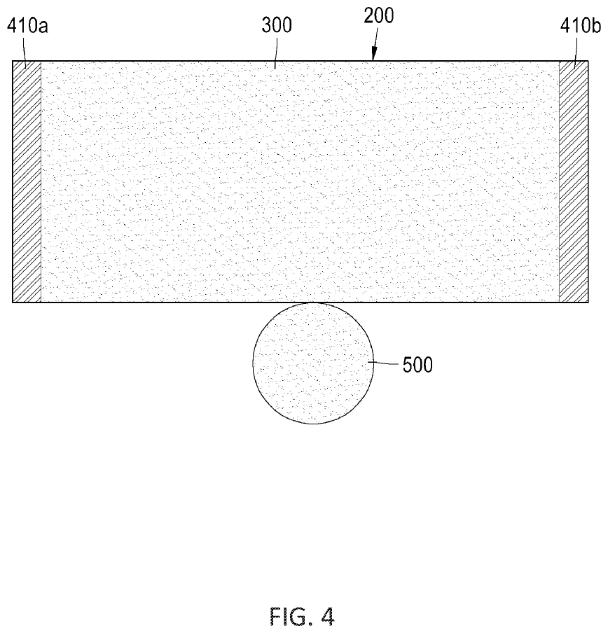

FIG. 4 is an unfolded exploded view illustrating a first insulating layer and a graphene layer of a heater pipe according to a second embodiment of the present disclosure. In the second embodiment, the first insulating layer 200 is a polyimide film, and the graphene layer 300 is deposited and formed on the polyimide film. In the present embodiment, the graphene layer 300 is deposited in a plane shape to continuously cover a significant portion of the first insulating layer 200, which is a polyimide film. Although not shown in the drawing, the second insulating layer 400 is formed later on the graphene layer 300 so that the graphene layer 300 is insulated from both upper and lower surfaces. The second insulating layer 400 may also be formed of a polyimide film. The connector portions 410a and 410b for electrical connection may also be formed on one side of the graphene layer 300. In addition, portions of the first insulating layer 200, the graphene layer 300, and the second insulating layer 400 may extend from the outer surface of the body to form an extension surface 500 substantially forming a lower surface of a pipe heater 1. The extension surface 500 may form the lower surface of the pipe heater 1, and heat may be transferred to the lower end portion of the aerosol-forming article inserted therein.

Among insulating films, the polyimide film has relatively high thermal conductivity and is suitable for transferring heat to the body 110. The first insulating layer 200, the graphene layer 300, and the second insulating layer 400 may be laminated in the form of a film to cover an outer periphery of the body 110 and may be attached to the outer surface of the body 110 using an adhesive, such as epoxy or bond, that is relatively heat-resistant and has high thermal conductivity.

In another embodiment, the extension surface 500 may be an etching film heater. That is, portions of the first insulating layer 200 and the second insulating layer 400 may extend to substantially form a lower surface of the pipe heater 1, and an etched exothermic pattern may be formed between the first insulating layer 200 and the second insulating layer 400 to configure only the extension surface 500 as an etched film heater.

In addition, in another embodiment, the first insulating layer may be formed on the outer surface of the body 110 by a coating process, such as deposition or spraying, and the second insulating layer 400 formed of a polyimide film, on which the graphene layer 300 is deposited, may be attached on the first insulating layer 200. Of course, these embodiments also have the same laminating order of the body 110, the first insulating layer 200, the graphene layer 300, and the second insulating layer 400 as in the first embodiment.

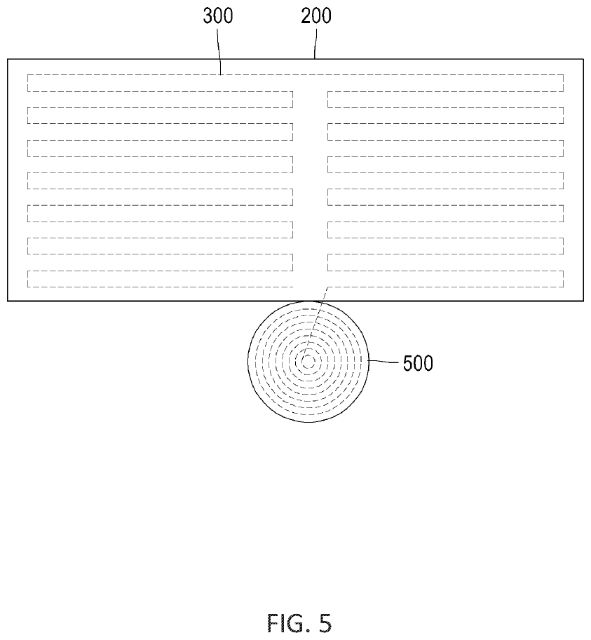

FIG. 5 is an unfolded exploded view illustrating a first insulating layer and a graphene layer of a heater pipe according to a third embodiment of the present disclosure. The present embodiment is similar to the second embodiment, except that the graphene layer 300 is deposited in a pattern shape to cover a significant portion of the first insulating layer 200, which is a polyimide film. Since the graphene layer 300 is deposited in a pattern shape to cover a significant portion of the first insulating layer 200, the required amount of graphene may be reduced, while the purpose of surface heating may be sufficiently achieved.

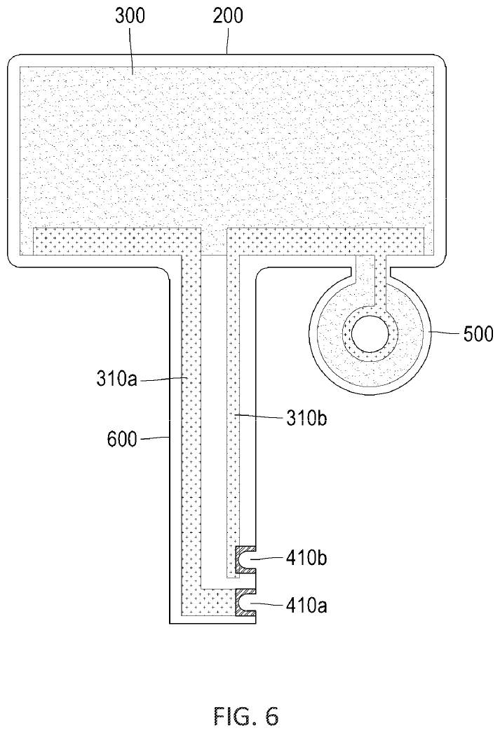

FIG. 6 is an unfolded exploded view illustrating a first insulating layer and a graphene layer of a heater pipe according to a fourth embodiment of the present disclosure. The present embodiment is similar to the third embodiment, except that portions of the first insulating layer 200 and the second insulating layer 400 (not shown in the drawing) extend to the outside of the body 110 to form an extension portion 600 and the connector portions 410a and 410b for connecting the graphene layer 300 to an external power source (not shown) are formed in the extension portion 600. In the present embodiment, at least one of the first insulating layer 200 and the second insulating layer 400 is a polyimide film, and preferably, a portion thereof extends below the body 110 to form the extension portion 600. In the extension portion 600, the electrode lines 310a and 310b extending from the graphene layer 300 extend, and connector portions 410a and 410b formed of, for example, solder pads, for easy electrical connection are formed at the final end. The extension surface 500 forming the lower surface of the heater pipe 1 may be a heating structure including the graphene layer 300 formed between the first insulating layer 200 and the second insulating layer 400 or an etching exothermic pattern (not shown) formed between the first insulating layer 200 and the second insulating layer 400.

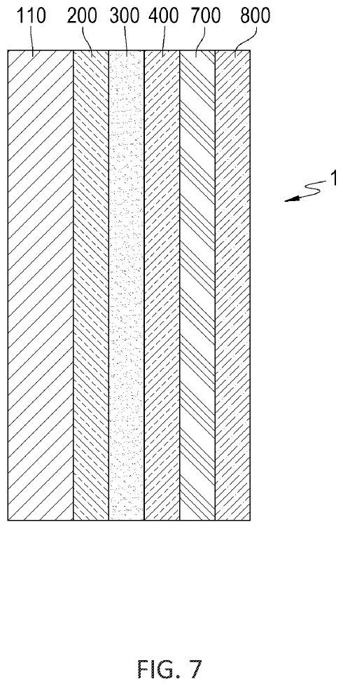

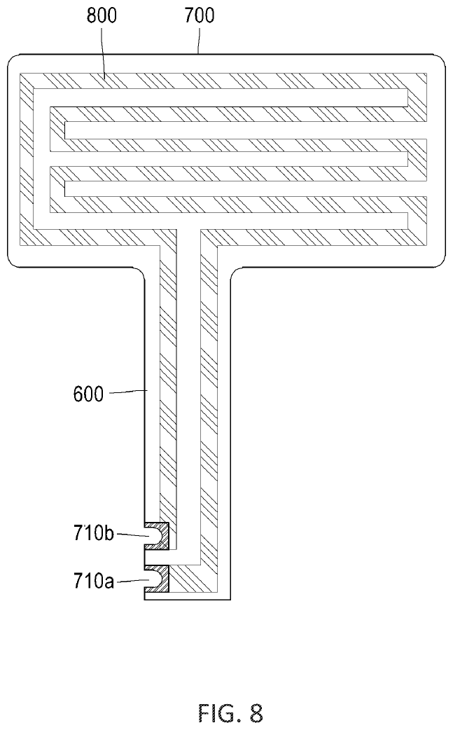

FIG. 7 is a partial cross-sectional view of a heater pipe according to a fifth embodiment of the present disclosure, and FIG. 8 is an unfolded exploded view illustrating an insulating film 800 and a sensor pattern 700 of a heater pipe according to the fifth embodiment of the present disclosure. The heater pipe 1 according to the fifth embodiment further includes a sensor layer 700 on which a sensor pattern 700 sensing a temperature is printed on the insulating film 800. In particular, the sensor pattern 700 may be disposed to face the second insulating layer 400 and may be formed to cover a significant portion of the body 110 to measure a temperature across the entire area of the body. As illustrated in FIG. 8, portions of the sensor layers 700 and 800 may extend outwardly together with the first insulating layer 200 and the second insulating layer 400 to form the extension portion 600. The sensor pattern 700 may continue to extend to the extension portion 600 to form terminal portions 710a and 710b at the final end. By forming the extension portion 600 extending below the body 110, the graphene layer 300 and the sensor pattern 700 may be easily connected to an external power source, such as a battery or a controller.

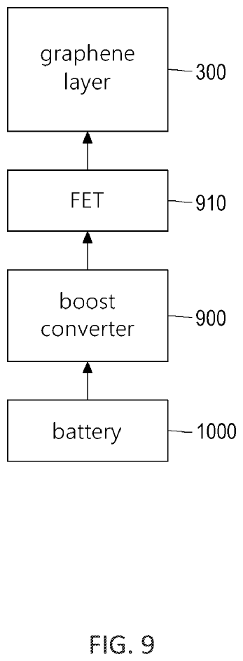

FIG. 9 is a block diagram illustrating a configuration of a heater pipe according to a sixth embodiment of the present disclosure. In the present embodiment, the graphene layer 300 is connected to a battery 1000, which is an external power source, via at least a boost converter 900. In addition to this, a field effect transistor (FET) device 910 may be added between the boost converter 900 and the graphene layer 300 for the purpose of control and circuit protection. The boost converter 900 is a converter that boosts a voltage between direct currents, and increases a voltage transferred from the external power source 1000 to the graphene layer 300 so that the heater pipe 1 may be boosted more quickly.

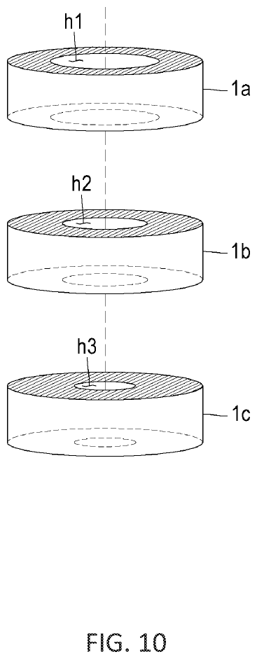

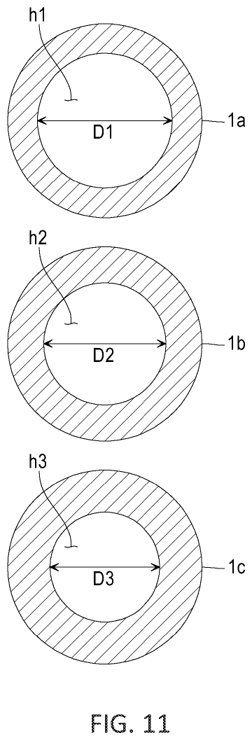

FIG. 10 is an exploded view of a laminated heater pipe that may be formed by laminating heater pipes according to an embodiment of the present disclosure, and FIG. 11 is a top view of each of laminated heater pipes. A laminated heater pipe may be formed by vertically laminating a plurality of heater pipes 1a, 1b, and 1c according to any of the embodiments described above. In particular, in the laminated heater pipe of the present disclosure, a cross-sectional area of a hollow of the heater pipe laminated at the bottom may be smaller than or equal to a cross-sectional area of a hollow of the heater pipe laminated at the top. Therefore, a width D1 of a hollow h1 of the uppermost heater pipe 1a may be greater than or equal to a width D2 of a hollow h2 of the heater pipe 1b laminated therebelow. In addition, a width D3 of a hollow h3 of the heater pipe 1c laminated at the lowermost heater pipe 1c may be smaller than or equal to the widths D1 and D2 of the hollows h1 and h2 of the heater pipes 1a, 1b laminated thereabove. By configuring the laminated heater pipe, while reducing the cross-sectional area of the hollows laminated toward the bottom, the aerosol-forming article inserted from the upper end of the hollow of the heater pipe may be easily inserted from the top and has I increased adhesion with an inner wall of the heater pipe, so that heat may be further easily transferred.

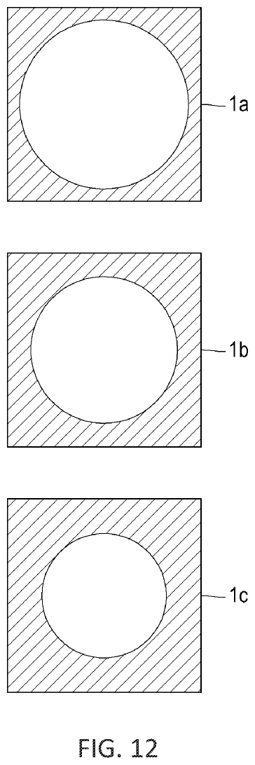

As illustrated in FIG. 11, cross-sections of outer surfaces of the heater pipes 1a, 1b, and 1c laminated according to an embodiment may be circular and cross-sections of the hollows may be circular. Also, in another embodiment, as illustrated in FIG. 12, cross-sections of outer surfaces of the heater pipes 1a, 1b, and 1c laminated according to an embodiment may be quadrangular and cross-sections of the hollows may be circular.

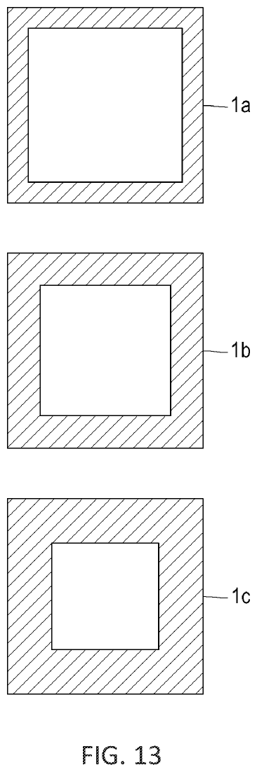

Also, in another embodiment, as illustrated in FIG. 13, cross-sections of outer surfaces of the heater pipes 1a, 1b, and 1c laminated according to an embodiment may be quadrangular and cross-sections of the hollows may also be quadrangular.

The heater pipe 1 of the present disclosure described above in various embodiments above may be included as a component in an aerosol generating device and used for the purpose of transferring heat to the aerosol-forming article. The graphene layer 300, which is an exothermic layer, has excellent electrical and thermal properties and is formed to cover a significant portion of the metal body 110 with the first insulating layer 200 interposed therebetween, so that heat may be evenly distributed transmitted to the body 110 formed of metal through the first insulating layer 200 over the entire area. In addition, since a heat-up time may be shortened, user experience of the aerosol generating device may be increased and current consumption may be reduced.

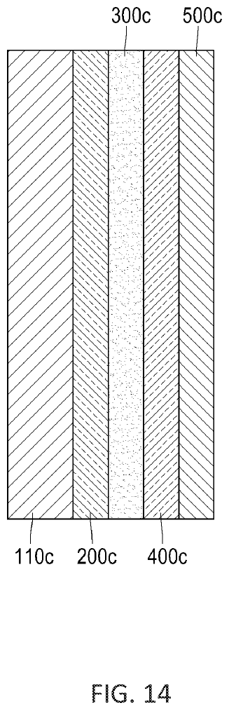

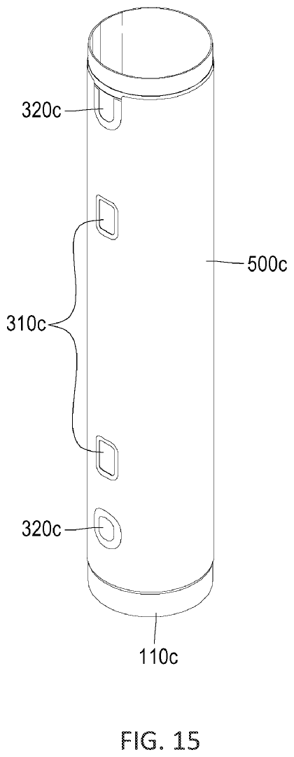

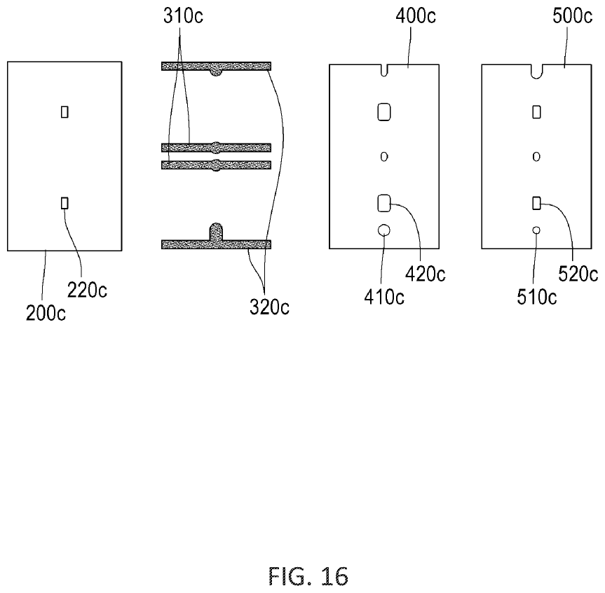

FIG. 14 is a partial cross-sectional view of a laminated heater pipe according to a seventh embodiment of the present disclosure, FIG. 15 is a perspective view of a laminated heater pipe according to the seventh embodiment of the present disclosure, and FIG. 16 is an exploded view illustrating each layer of a laminated heater pipe according to the seventh embodiment of the present disclosure.

In the laminated heater pipe according to the seventh embodiment, a first insulating layer 200c is formed on an outer surface of a metal body 110c, and an electrode layer 300c is formed thereon. The electrode layer 300c may include electrodes 310c and 320c, which are conductive printed patterns to which a power line is soldered, and a conductive pattern conducting the negative (−) electrode 310c, and the positive (+) electrode 320c.

A thin film 400c is formed on the electrode layer 300c by coating a paste composition including platinum-based ruthenium, palladium, or silver as an exothermic layer and sintering. After the paste composition including platinum-based ruthenium, palladium, or silver is applied on the electrode layer 300c, a second insulating layer 500c is formed, and a heater pipe is manufactured through sintering and compression molding. The thin film 400c generates heat by power applied through the electrode layer 300c, and since the thin film 400c is formed by applying a paste composition, sintering, and compressing, it is light in weight and may be easily manufactured.

At this time, the first insulating layer 200c may be formed of a glass-ceramic layer, the electrodes 310c and 320c may be formed of silver, the thin film 400c may be formed of a composition obtained by mixing silver and palladium or a composition obtained by mixing silver and ruthenium, and the second insulating layer 500c may be formed of a glass layer. At this time, the thin film 400c may have a composition having resistance of 0.6 to 1.4Ω measured in the electrode layer 300c. For example, the paste composition for forming the thin film 400c may include 10 to 60 parts by weight of silver, 0.25 to 20 parts by weight of palladium, 10 to 40 parts by weight of an organic compound, and 0.01 to 20 parts by weight of others, or may include 10 to 60 parts by weight of silver, 0.25 to 20 parts by weight of ruthenium, 10 to 40 parts by weight of an organic compound, and 0.01 to 20 parts by weight of others.

At this time, the thin film 400c and the second insulating layer 500c include electrode exposure holes 410c and 510c to expose the electrodes 310c and 320c of the electrode layer 300c to solder power lines, respectively.

Meanwhile, in order to control heat generating of the heater pipe, the first insulating layer 200c, the thin film 300c, and the second insulating layer 500c may include holes 220c, 420c, and 520c formed at positions overlapping each other to expose the body 110c to measure a temperature of the body 110c.

A thermocouple (not shown) may be attached to the body 110c exposed through the holes 220c, 420c, and 520c to measure the temperature of the body 110c, and based on the value, a current applied through the electrodes 310c and 320c may be controlled to control a heating value of the heater pipe.

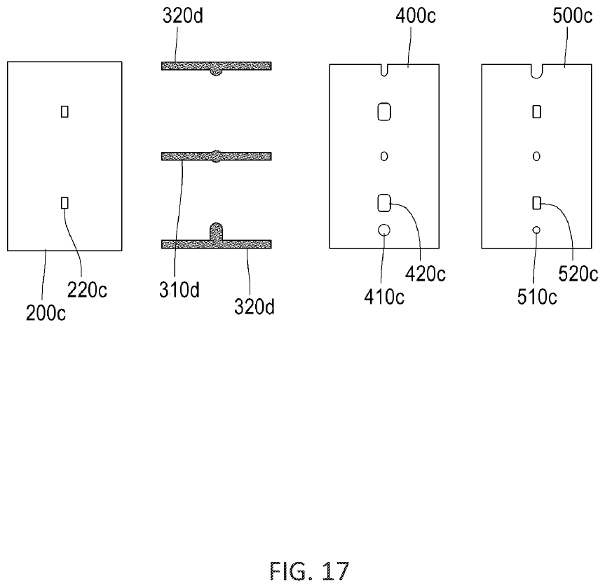

FIG. 17 is an exploded view illustrating each layer of a laminated heater pipe according to an eighth embodiment of the present disclosure.

The laminated heater pipe according to the eighth embodiment of the present disclosure has almost the same configuration as that of the seventh embodiment and differs from the seventh embodiment only in the number and arrangement of the electrodes 310d and 320d of the electrode layer 300d.

Among the electrodes 310d and 320d of the electrode layer 300d, two positive (+) electrodes 320d are formed, while the negative (−) electrode 310d may be used as a common electrode.

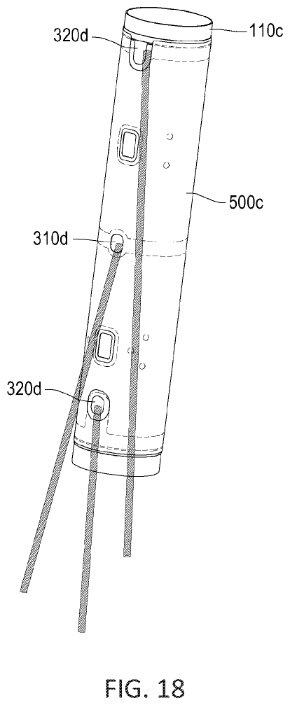

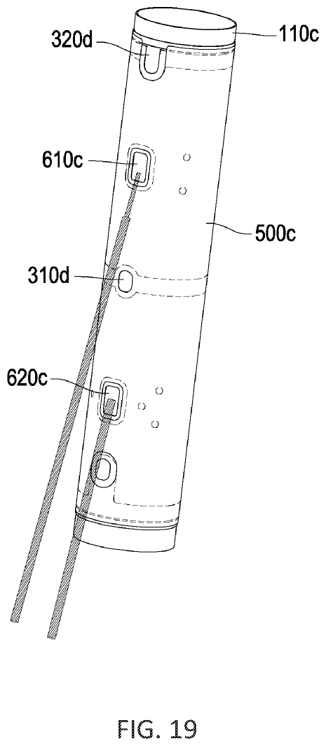

FIGS. 18 and 19 are perspective views of a laminated heater pipe according to the eighth embodiment of the present disclosure.

Meanwhile, it is illustrated that power supply lines are soldered to the electrodes 310d and 320d of the heater pipe and a thermocouple 610c is attached to the body 110c exposed through the holes 220c, 420c, and 520c (refer to FIG. 17). In order to control heat generating, the first insulating layer 200c, the thin film 300c, and the second insulating layer 500c include holes 220c, 420c, and 520c formed at overlapping positions to expose the body 110c to measure a temperature of the body 110c.

A thermocouple (not shown) may be attached to the body 110c exposed by the holes 220c, 420c, and 520c to measure a temperature of the body 110c, and based on the value, a current applied through the electrodes 310d and 320d may be controlled to control a heating value of the heater pipe.

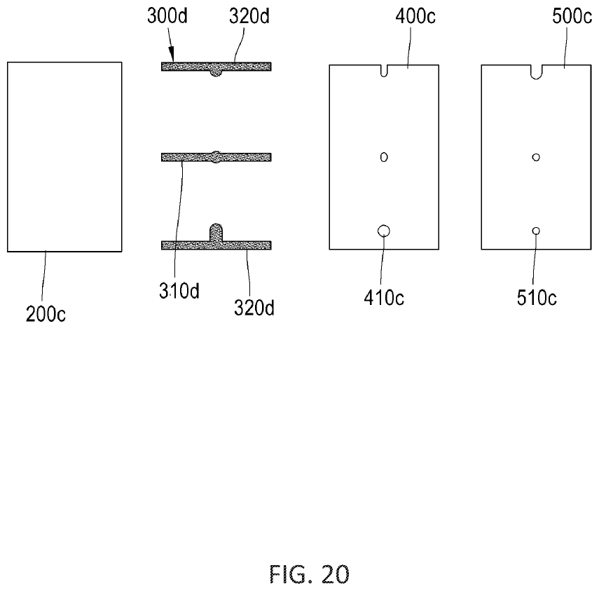

FIG. 20 is an exploded view illustrating each layer of a laminated heater pipe according to a ninth embodiment.

The laminated heater pipe according to the embodiment of FIG. 9 is the same as that of the eighth embodiment, except that a separate hole for attaching A thermocouple is not formed. Instead, resistance TCR connected to the electrodes 310d and 320d of the electrode layer 300d is measured and used to control the temperature of the heater. When heat is generated by power applied to the electrode layer 300d, a temperature change resistance (TCR) value of the thin film 400c formed of ruthenium, palladium, and silver is used for temperature control.

As described above, the present disclosure is not limited to the specific embodiments described above, and it would be appreciated by those skilled in the art that changes may be made in the aspects without departing from the principles and spirit of the invention, the scope of which is defined in the claims and their equivalents.

What is claimed is:

1. A heater pipe for an aerosol generating device for transferring heat to an aerosol-forming article, the heater pipe comprising:
a body formed of metal and having a shape of a hollow pipe for accommodating the aerosol-forming article;
a first insulating layer formed on an outer surface of the body;
an exothermic layer formed on the first insulating layer by deposition; and
a second insulating layer formed on the exothermic layer.

2. The heater pipe of claim 1, wherein the exothermic layer is a graphene layer.

3. The heater pipe of claim 2, further comprising:
a connector portion formed by removing a portion of the second insulating layer, and exposed to the outside,
wherein the graphene layer is connected to an external power source through the connector portion.

4. The heater pipe of claim 2, wherein the graphene layer is formed by depositing graphene in a pattern.

5. The heater pipe of claim 2, wherein at least one of the first insulating layer and the second insulating layer is a polyimide film.

6. The heater pipe of claim 5, wherein the first insulating layer, the graphene layer, and the second insulating layer partially extend from the outer surface of the body to form a lower surface of a pipe heater.

7. The heater pipe of claim 5, wherein the first insulating layer and the second insulating layer have an extension portion partially extending to the outside of the body, and a connector portion connecting the graphene layer to an external power source is formed on the extension portion.

8. The heater pipe of claim 5, further comprising:
a sensor layer attached to an outer surface of the second insulating layer and having a sensor pattern for sensing a temperature printed on the insulating film.

9. The heater pipe of claim 8, wherein the first insulating layer, the second insulating layer, and the sensor layer have an extension portion partially extending to the outside of the body, and a connector portion connecting the graphene layer to an external power source and a terminal portion extending from the sensor pattern are provided on the extension portion.

10. The heater pipe of claim 5, wherein the first insulating layer and the second insulating layer partially extend from the outer surface of the body to form a lower surface of a pipe heater, and an etched exothermic pattern is formed between the first insulating layer and the second insulating layer of the lower surface.

11. The heater pipe of claim 2, wherein the graphene layer is connected to an external power source through a boost converter to increase a supplied voltage.

12. A laminated heater pipe formed by vertically laminating a plurality of heater pipes of claim 1, wherein a cross-sectional area of a hollow of a heater pipe laminated at the bottom is smaller than or equal to a cross-sectional area of a hollow of a heater pipe laminated at the top.

13. The laminated heater pipe of claim 12, wherein a cross-section of an outer surface of the laminated heater pipe is circular, and a cross-section of the hollow thereof is also circular.

14. The laminated heater pipe of claim 12, wherein a cross-section of an outer surface of the laminated heater pipe is quadrangular, and a cross-section of the hollow thereof is circular.

15. The laminated heater pipe of claim 12, wherein a cross-section of an outer surface of the laminated heater pipe is quadrangular, and a cross-section of the hollow thereof is also quadrangular.

16. The laminated heater pipe of claim 12, further comprising:
an electrode layer printed on the first insulating layer,
wherein an exothermic layer is formed on the electrode layer, and is a thin film formed by applying a paste composition including at least one of platinum-based ruthenium, palladium, and silver and then sintering.

17. The laminated heater pipe of claim 16, wherein the exothermic layer has an electrical resistance of 0.6Ω to 1.4Ω.

18. The laminated heater pipe of claim 16, wherein the electrode layer includes one or more negative (−) electrodes and two or more positive (+) electrodes.

19. The laminated heater pipe of claim 18, wherein the exothermic layer and the second insulating layer each have an electrode exposure hole exposing the electrode of the electrode layer, and a wire for applying power is connected to the electrode.

20. The laminated heater pipe of claim 18, wherein a temperature change resistance (TCR) of the exothermic layer connected to the electrode layer is measured and used to control a temperature of a heater.

21. The laminated heater pipe of claim 16, wherein the first insulating layer, the exothermic layer, and the second insulating layer have a hole located at overlapping positions to expose the heater pipe, and wherein the laminated heater pipe further includes a thermocouple for temperature measurement directly welded to the heater pipe exposed through the hole.

22. An aerosol generating device comprising the heater pipe of claim 1.
